(19) United States
(12) Patent Application Publication
(10) Pub. No.: US 2006/0020490 A1
(43) Pub. Date: Jan. 26, 2006

(54) Database and model for monitoring and predicting outcomes with vascular access devices

(76) Inventor: Paul E. Staton JR., New Palestine, IN (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 10/927,554

(22) Filed: Aug. 26, 2004

Related U.S. Application Data
(60) Provisional application No. 60/589,464, filed on Jul. 20, 2004.

(51) Int. Cl. G06Q 50/00

(52) U.S. Cl. 705/2; 128/898

(57) ABSTRACT

A method is provided for monitoring and predicting usage and health outcomes with respect to the utilization of vascular access devices.

### RELATED APPLICATIONS

This invention claims priority to Provisional Application Ser. No. 60/589,464, filed Jul. 20, 2004, the specification of which is expressly incorporated herein.

### FIELD OF THE INVENTION

This invention relates to monitoring medical treatment and mining the databases to allow early detection and interception of patients in need of extra attention. More specifically, this invention relates to databases for monitoring and tracking of medical care with respect to vascular access devices and predictive modeling using the monitoring and tracking data to detect and intercept vascular access devices that are performing at a sub-optimal level.

### BACKGROUND AND SUMMARY OF THE INVENTION

Hospitals and other medical care facilities typically place many intravenous lines (IVs), peripherally inserted central catheters (PICCs), or other vascular access devices a year. Such vascular access device placements sometimes result in negative side effects and/or outcomes, such as infections and devices that become disengaged from the patients or otherwise non-functioning.

According to a first embodiment of the invention, a method of monitoring a vascular access device is provided including the steps of identifying a plurality of characteristics relating to the vascular access device, observing conditions corresponding to the characteristics, recording data for each characteristic based upon the corresponding observed condition, and calculating an indication of performance of the vascular access device based upon the recorded data.

According to another embodiment of the present invention, a method of predicting healthcare outcomes with respect to the use of a vascular access device is provided including the steps of administering a vascular access device to a patient, periodically observing a plurality of pre-determined characteristics relating to the vascular access device, recording data representing the periodic observations, and generating an indication of a likely healthcare outcome with respect to the use of the vascular access device based on the recorded data.

According to yet another embodiment of the present invention, a method of maintaining the health of patients utilizing a vascular access devices including the steps of administering vascular access devices to a plurality of patients, periodically observing characteristics of the vascular access devices, recording the characteristics of the vascular access devices, determining the characteristics having a correlation to an ultimate healthcare outcome with respect to the vascular access system, using the correlated characteristics to provide a predictive system of vascular access device health, administering a first vascular access device to a first patient, recording correlated characteristics of the first vascular access device, and receiving a report on the current health of the patient and likely healthcare outcome of the patient with respect to the vascular access device.

According to still another embodiment of the present invention, a method of maintaining the health of a patient utilizing a vascular access device including the steps of recording pre-determined characteristics of a first vascular access device, and receiving a report describing the current health of the patient and likely health outcome of the patient with respect to the vascular access device. The report is produced by a predictive system. The predictive system is populated by administering vascular access devices to a plurality of patients, periodically observing the vascular access devices, recording characteristics of the vascular access devices, and determining the characteristics having a correlation to the ultimate healthcare outcome with respect to the use of the vascular access system.

Additional features of the present invention will become apparent to those skilled in the art upon consideration of the following detailed description of the invention.

### BRIEF DESCRIPTION OF THE DRAWINGS

FIGS. 1a and 1b are sample patient reports generated by a grading and prediction system; and

FIG. 2 is a daily log report generated by the grading and prediction system.

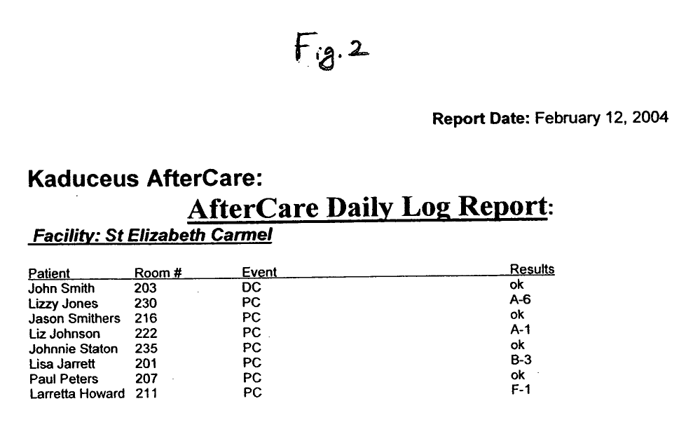

### DETAILED DESCRIPTION OF EMBODIMENTS OF THE INVENTION

The embodiments selected for description below are not intended to be exhaustive or to limit the invention to the precise forms disclosed. Rather, the embodiments were selected to enable one of ordinary skill in the art to practice the invention.

PICC lines, used herein as an example of vascular access devices in general and interchangeably with IVs, are used in patient care settings to deliver nutrition, drugs, blood, and other fluids to patients. Installation of PICC lines is preferably performed by trained professionals. Installation of a PICC line is followed within 48 hours, preferably within 24 hours, by dressing removal, clean up of the PICC entry site, and re-dress of the entry site. After the initial re-dress, PICC lines and the associated patient, equipment, and environment (collectively referred to herein as “characteristics”) are regularly inspected. The inspection involves a caregiver observing conditions corresponding to the characteristics. The characteristics assessed for each PICC line are shown in Exhibit A. It should be understood, however, that fewer than all of these characteristics may be considered, or additional characteristics may be included depending upon the vascular access device being assessed or other factors. This assessment is commonly referred to as a “PICC check.” Many patients, each having a PICC line, are often present within a single patient care facility. Therefore, a caregiver may go from patient to patient performing multiple PICC checks in a single visit to the facility.

Each PICC check allows the caregiver to evaluate the condition of the PICC line and the maintenance being provided thereto. Assessment is performed using various characteristic categories (examples shown in Exhibit A) and a grading system associated therewith. In one embodiment of the invention, each PICC line is initially given a grade of 10. As less than optimal PICC line characteristics are discovered, the assessment decreases the grade of that PICC line by a predetermined value for each less than optimal characteristic that is found. While the amount of the deduction is initially estimated to approximate its severity with respect to effect upon the patient, the deducted amount is eventually a product of placing the data in a predictive model as is discussed in more detail below.

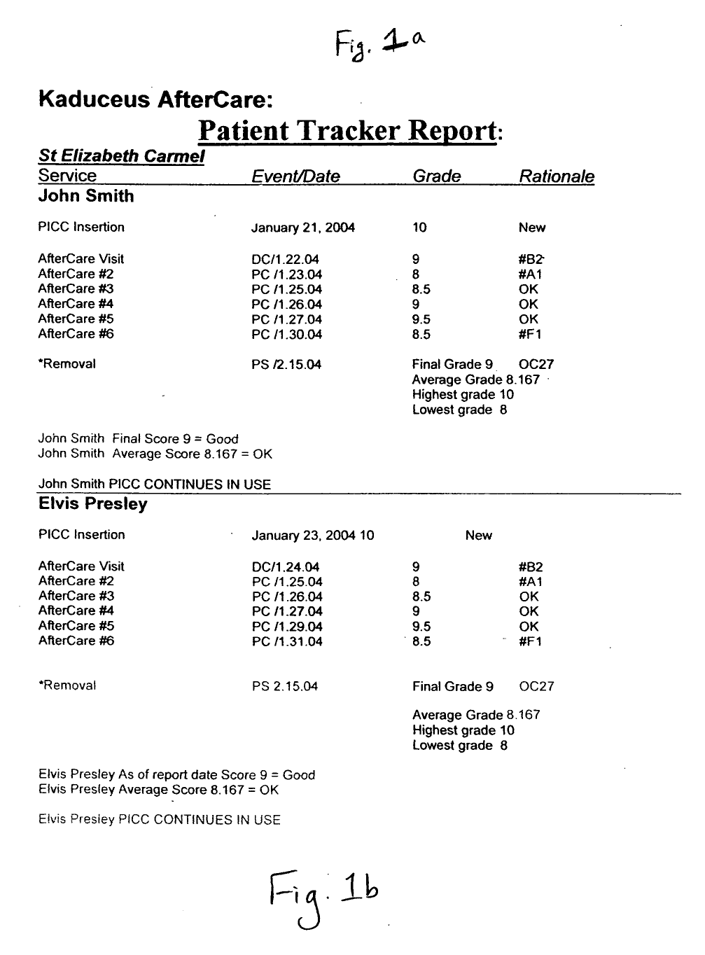

As an example, if a caregiver finds that a suture is missing from a PICC line site, or the dressing is partially removed, a full point is deducted from that PICC's initial score of 10. If more than one suture is found missing, the incremental reduction for the second missing suture may only be quarter of a point. The gradings and observed conditions are kept in a database (or databases) that is accessible to caregivers within the care facilities. The database is also able, through a software interface, to provide a report to describe the condition of the PICC line. (FIGS. 1 & 2) The software interface allows a hospital administrator or PICC line administrator to customize a report of PICC line conditions. Such a software interface is located on a computer, preferably networked, that has access to the database. The software accesses the database and uses the stored PICC line characteristics to provide the customized report.

PICC line current scores are produced after each grading. After a PICC line is intentionally removed, the software and database provide an average score and a final score. These scores are compared to a legend, such as the example shown in Exhibit B, to provide meaning to the scores. Each data point and score is also used to iteratively update a predictive model. The predictive model is created using the observed statistics and any method known in predictive modeling and artificial intelligence. (Examples: neural networks, learning agents, decision trees, etc.). Such a model compares the measured characteristics and the PICC line outcomes to determine which characteristics have a relationship to the ultimate PICC line outcome. Characteristics having a close relationship to the PICC line outcome are given greater predictive weight. Characteristics having no relationship to the PICC line outcome may be dropped from the list of characteristics for the caregiver to observe and record. Attachment A includes an illustrative list of the type of events that are monitored and entered into the model.

As previously mentioned, additional characteristics to record and factor into the analysis are added as needed. Such factors may include the number of caregivers who interact with the patient, the size of the patient's room, number of visitors, length of stay, number of caregiver approaches to the vascular access device, or any other characteristic that could possibly affect the healthcare outcome. These characteristics can be observed directly on the patient, in the patient's room, from a work order calling for a PICC, from a procedure checklist, from a demographic form, from an aftercare log, by observing the healthcare outcome, or elsewhere. Additional characteristics are typically added when the caregiver finds that the current list of characteristics is not providing accurate predictions. Additional characteristics are added until the group of characteristics is able to provide accurate predictions. As also noted, characteristics with no predictive value are typically removed from the list of characteristics for a caregiver to record so as to allow the caregiver to complete the assessment quicker, prevent taking superfluous data, and prevent superfluous data from taking up storage space.

Once properly populated and trained, the predictive model allows caregivers to identify patients who are likely to encounter complications with their PICC line. Additional supervision can be allocated to the increased risk patients and preventative measures (drugs, re-dressing, installation of a new PICC, etc.) can be administered thereto. Thus, a database is provided that records data regarding conditions that are predictive of PICC line conditions and also provides the data for a prediction model of PICC line future condition. Additionally, the predictive model may be trained to output a suggested caregiver action in addition to the PICC line condition.

This database and predictive model are preferably stored on a server that is accessible by a plurality of networked computers. The database and model are preferably licensed to healthcare facilities and providers. Each hospital can have a private database and prediction system on site or may link to a central database and prediction system off-site that may incorporate data from many healthcare facilities.

Although the invention has been described in detail with reference to certain preferred embodiments, variations and modifications exist within the scope and spirit of the present invention.

1. A method of monitoring a vascular access device including the steps of:
identifying a plurality of characteristics relating to the vascular access device;
observing conditions corresponding to the characteristics;
recording data for each characteristic based upon the corresponding observed condition; and
calculating an indication of performance of the vascular access device based upon the recorded data.

2. The method of claim 1, wherein the calculated indication is a numerical value.

3. The method of claim 1, wherein the data is recorded in a database.

4. The method of claim 1, wherein a predictive model is applied to data to determine which characteristics are indicative of the performance of the vascular access device.

5. The method of claim 1, wherein the data includes subjective observations.

6. The method of claim 1, further including the step of generating a report of information indicating the performance of the vascular device over time.

7. The method of claim 1, wherein the calculated performance indication is provided by a predictive model.

8. The method of claim 7, wherein the predictive model is created and updated using artificial intelligence techniques.

9. A method of predicting healthcare outcomes with respect to the use of a vascular access device including the steps of:
administering a vascular access device to a patient;
periodically observing a plurality of pre-determined characteristics relating to the vascular access device;
recording data representing the periodic observations; and
generating an indication of a likely healthcare outcome with respect to the use of the vascular access device based on the recorded data.

10. The method of claim 9, wherein the recording step includes the step of inputting the data into a database.

11. The method of claim 9, wherein the indication is generated by a predictive model.

12. The method of claim 11, wherein the predictive model is created and updated using artificial intelligence techniques.

13. The method of claim 11, wherein the predictive model assigns weights to the data corresponding to each of the characteristics, the weights being a function of the ability of the characteristic to predict the healthcare outcome with respect to the vascular access device.

14. The method of claim 9, wherein the indication is expressed as a number.

15. The method of claim 14, wherein the number correlates to a level of observable care being provided to the patient.

16. The method of claim 14, wherein the number correlates to a current state of the vascular access device.

17. The method of claim 9, further including the step of receiving a recommended caregiver action.

18. A method of maintaining the health of patients utilizing a vascular access devices including the steps of:
administering vascular access devices to a plurality of patients;
periodically observing characteristics of the vascular access devices;
recording the characteristics of the vascular access devices;
determining the characteristics having a correlation to an ultimate healthcare outcome with respect to the vascular access system;
using the correlated characteristics to provide a predictive system of vascular access device health;
administering a first vascular access device to a first patient;
recording correlated characteristics of the first vascular access device; and
receiving a report on the current health of the patient and likely healthcare outcome of the patient with respect to the vascular access device.

19. The method of claim 18, wherein the report is generated by the predictive model.

20. A method of maintaining the health of a patient utilizing a vascular access device including the steps of:
recording pre-determined characteristics of a first vascular access device; and
receiving a report describing the current health of the patient and likely health outcome of the patient with respect to the vascular access device, the report being produced by a predictive system, the predictive system being populated by administering vascular access devices to a plurality of patients, periodically observing the vascular access devices, recording characteristics of the vascular access devices, and determining the characteristics having a correlation to the ultimate healthcare outcome with respect to the use of the vascular access system.

21. The method of claim 20, wherein the characteristics are recorded in a database.

22. The method of claim 21, wherein the database and predictive system are accessible over a network by a plurality of computers.

23. The method of claim 22, wherein users are provided with licenses to utilize the predictive system.
